(19) United States
(12) Patent Application Publication
(10) Pub. No.: US 2016/0350654 A1
(43) Pub. Date: Dec. 1, 2016

(54) INTELLIGENT HOME SYSTEM AND METHOD

(71) Applicant: WEN-SUNG LEE, TAICHUNG CITY (TW)

(72) Inventor: WEN-SUNG LEE, TAICHUNG CITY (TW)

(21) Appl. No.: 15/233,106

(22) Filed: Aug. 10, 2016

Related U.S. Application Data
(63) Continuation-in-part of application No. 13/956,364, filed on Aug. 1, 2013.

(51) Int. Cl. G06N 3/08

(52) U.S. Cl. CPC G06N 3/08; G05B 2219/2642

(57) ABSTRACT

An intelligent home system installed in a house and interacted with appliances in the house comprises an identification device; a locating device; and an artificial neural device; the artificial neural device includes a recording unit, a learning unit, and a decision making unit, the recording unit, the learning unit, and the decision making unit are transmitted signals to one another, the recording unit records and stores the ID information, the coordinate information, and a control information of each appliance which is adjusted by the user, the learning unit reads the ID information, the coordinate information, and the control information so as to automatically learn and integrate to generate an integrated data, and the decision making unit reads the integrated data to adjust the appliances to an operational status which the user is used to.

### CROSS-REFERENCE TO RELATED APPLICATION

This is a continuation-in-part of co-pending application Ser. No. 13/956,364, filed on Aug. 1, 2013, currently pending.

### BACKGROUND OF THE INVENTION

1. Field of the Invention

The present invention relates to an intelligent home system and method, and more particularly to an intelligent home system and method that may automatically adjust each appliance in the house to the operational status which the user is used to be judging, learning, recording, and predicting after identifying the identity of the user(s).

2. Description of the Related Art

General home environment can be divided into a plurality of regions, such as living room, study, bedroom, kitchen and toilet, and each region will be provided with a variety of electronic devices, such as air conditioner, lighting, acoustics, fans, and etc., each person different state of the environment is different regional needs. In order to be in a comfortable environment, when a user enters a region in the past, the user must start each an air conditioner temperature to the remote control, lamp brightness, sound, or the size of the fan, and to start later then individually adjust the electronic installations state, the state of the environment in line with their needs.

Conventionally, because of the user must manually manipulate the remote control to activate or deactivate the electronic device (appliance), to leave might forget to turn off electrical apparatus (appliance), or unnecessary excessive energy consumption, the relevant industry related R&D and improvement to sense the people to enter, to automatically open and close an electronic device, such as Taiwanese Patent Publication No. M413889, M270788, M441805 and the United States Patent U.S. Pat. No. 7,142,652 and U.S.20120306661. The following detailed description of Taiwanese Patent Publication No. M441805 “power saving control device” to connect A target device. The power saving control means comprises a control module, which controls at least one target device operating mode; a detection module to detect the environmental conditions of a one environment to produce a detection information; a communication module, which a power saving control device by remote electronic means by this communication module is connected; and a processing unit electrically connected to the control module, the detection module and the communication module by remote electronic means by that enter at least one default value, and the communication module transmits the at least one default value to the processing unit stores the processing unit also receives the detection information, when the processing unit determines the detection information in line with the default value to the control module controls the target device to This operating mode should default values.

The prior art borrowed from the remote electronic devices enter a default value, and communication module transmits the default value to the processing unit storing. The processing unit also receives detection information. The processing unit determines when the detection information corresponds to the default value and then the user may control module controls the target device run-mode corresponds to the default values. Thus, the energy saving effect may be achieved. The main application-specific computer program may automatically turn on the target device operation. However, there is need for a more intelligent than the prior art device.

### SUMMARY OF THE INVENTION

An main objective of the present invention is to provide an intelligent home system and method which are capable for recording, learning, and predicting. The identity of the user in the house may be identified and the appliances in the house may be automatically controlled and adjusted to an operational status which the user is used to so as to achieve the effects of intelligent activation and controlling environment.

An intelligent home system which is installed in a house and interacted with appliances arranged in the house may comprise an identification device, identified an identity of an user stayed in the house and outputted an ID information of the user; a locating device, detected a coordinate of the user stayed in the house and outputted a coordinate information; and an artificial neural device, electrically connected with the identification device and the locating device, the artificial neural device includes a recording unit, a learning unit, and a decision making unit, the recording unit, the learning unit, and the decision making unit are transmitted signals to one another, the recording unit records and stores the ID information, the coordinate information, and a control information of each appliance which is adjusted by the user, the learning unit reads the ID information, the coordinate information, and the control information recorded and stored in the recording unit so as to automatically learn and integrate to generate an integrated data, and the decision making unit reads the integrated data to adjust the appliances to an operational status which the user is used to.

The intelligent home system may further comprise a time tracker electrically connected with the recording unit, the time tracker continuously records a staying time of the user who stays in the coordinate and then transmit a time information to the recording unit to store.

In some embodiment, the artificial neural device further comprises a ranking unit electrically connected with the recording unit and the learning unit, and the ranking unit stores a plurality of priority information of different users which customizes in the operational status.

In some embodiment, the artificial neural device further comprises a judging unit electrically connected with the recording unit and the learning unit, and a newest control information is read while the judging unit judges that the ID information and the corresponding coordinate information are corresponding to a plurality of control information.

The intelligent home system may further comprise a controller, the controller is electrically connected with the recording unit so as to transmit the control information to the recording unit, and the controller includes an independent user interface or a corresponding transferring communication apparatus.

An intelligent home method is further provided and comprises the steps of: an identifying step: identifying an identity of an user with an artificial neural device while the user enters a house; a locating step: detecting a coordinate of the user with the artificial neural device while the user enters the house; a recording step: recording the identity, the coordinate and a control information of each appliance which is adjusted by the user with the artificial neural device at any time; a learning step: automatically learning and integrating an operational status which the user is used to in the coordinate according to the recording step; and a predicting step: judging and predicting which appliances the user wants to operate and what kind of the operational status of the appliances is so as to customize for the user by cooperating with the identity and the coordinate after finishing the identifying step and the locating step.

In some embodiment, the recording step further includes recording a time information in a specific coordinate where the user stays and recording the time information, the identity, the coordinate, and the operational status of the appliances in a time interval when the user stays in the specific coordinate with the artificial neural device; in the learning step, according to the recording step, the artificial neural device automatically learns and integrates the operational status of each appliance which the user is used to corresponding to the time information and the coordinate; and in the predicting step, according to the learning step, which appliances the user wants to operate and what kind of the operational status of the appliances is are judged and predicted so as to customize for the user by cooperating with the identity and the coordinate after finishing the identifying step and the locating step.

The intelligent home method may further comprise a multiple-user mode step which is performed after the recording step and before the learning step; in the identifying step and the locating step, when the artificial neural device detects a plurality of identities, a priority is judged in the learning step; in the predicting step, the artificial neural device judges and predicts which appliances the user wants to operate and what kind of the operational status of the appliances is so as to customize for the user who is the first priority by cooperating with the identity and the coordinate.

The intelligent home method may further comprise a monitoring environment step, the artificial neural device records a temperature and a humidity inside and outside of the house and monitors the identity of the user in the house, the number of the users in the house, and the operational status of each appliance, and then the artificial neural device transmits the information of the identity of the user in the house, the number of the users in the house, and the operational status of each appliance to a display device for providing the user to read.

In some embodiment, in the learning step, the artificial neural device judges whether there is a new control information so as to adjust the appliances to the operational status which the user is used to according to the recording step and cooperating with the identity, the coordinate, and the time information.

Further benefits and advantages of the present invention will become apparent after a careful reading of the detailed description with appropriate reference to the accompanying drawings.

### BRIEF DESCRIPTION OF THE DRAWINGS

A intelligent home system and method according to the invention will now be described, by way of example, with reference to the accompanying drawings, in which:

FIG. 1 is a block diagram of an intelligent home system;

FIG. 2 is a block diagram of the intelligent home system while is applied;

FIG. 3 is a cross-sectional view of the intelligent home system installed in a house and stayed a single one user therein;

FIG. 4 is a cross-sectional view of the intelligent home system installed in the house and stayed multiple users therein;

FIG. 5 is an operational view of a controller of the intelligent home system; and

FIG. 6 is a flow chart of the intelligent home method.

### DETAILED DESCRIPTION OF EMBODIMENTS

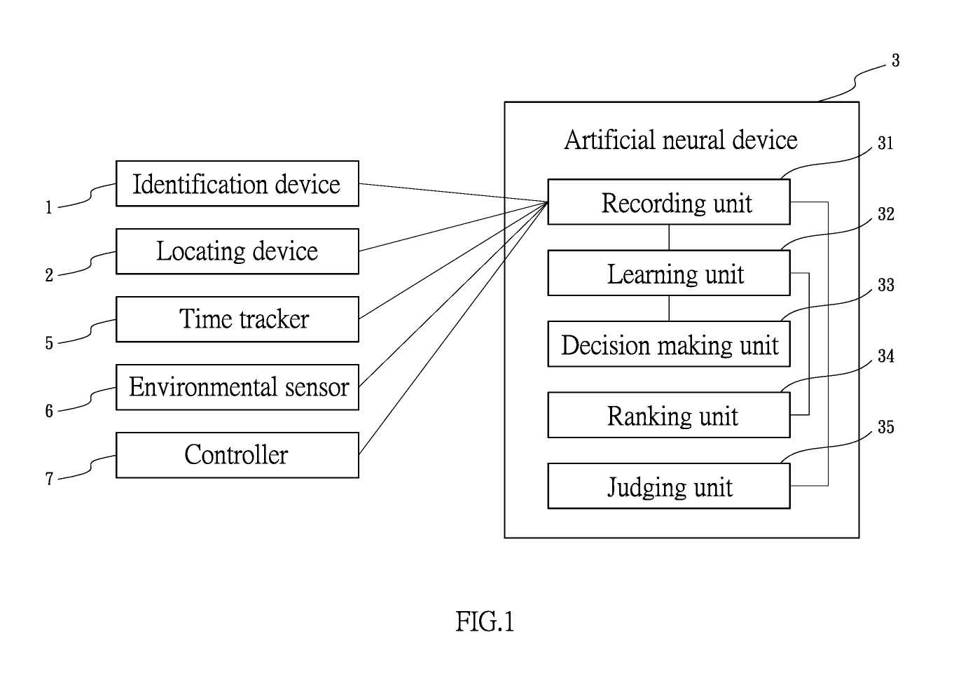

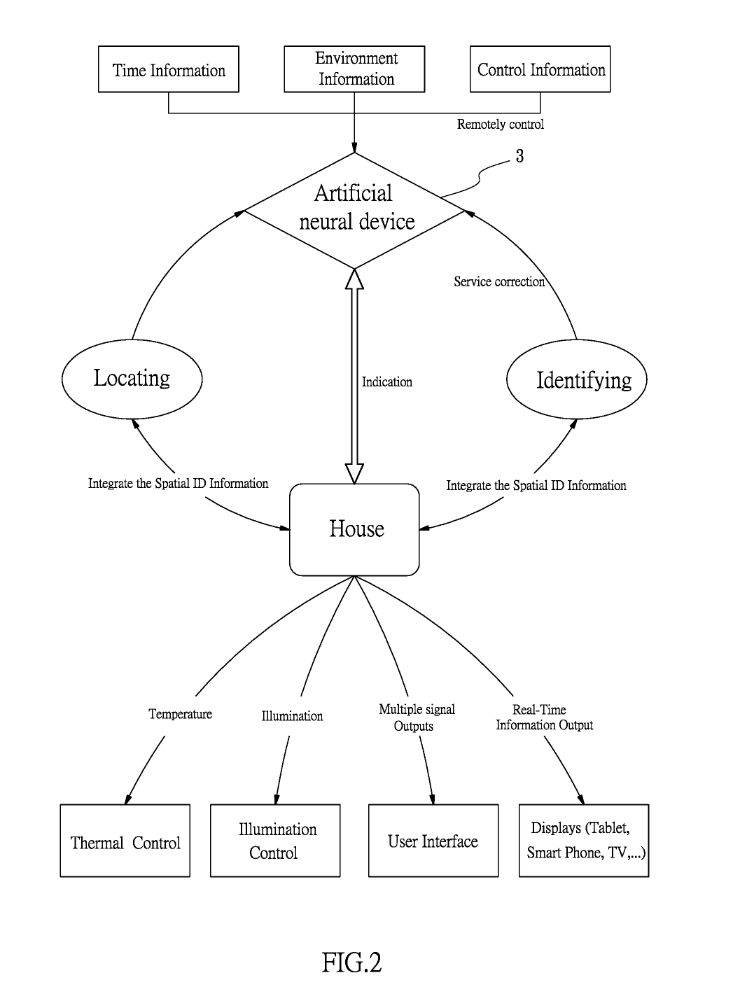

Please refer to FIGS. 1 and 2, an intelligent home system of the present invention is installed in a house and interacted with appliances arranged in the house. The intelligent home system comprises an identification device 1, a locating device 2, and an artificial neural device 3. The identification device 1 is identified an identity of an user stayed in the house and outputted an ID information of the user. The locating device 2 is detected a coordinate of the user stayed in the house and outputted a coordinate information. The artificial neural device 3 is electrically connected with the identification device 1 and the locating device 2. The artificial neural device 3 includes a recording unit 31, a learning unit 32, and a decision making unit 33. The recording unit 31, the learning unit 32, and the decision making unit 33 are transmitted signals to one another. The recording unit 31 records and stores the ID information, the coordinate information, and a control information of each appliance 4 which is adjusted by the user. The learning unit 32 reads the ID information, the coordinate information, and the control information recorded and stored in the recording unit 31 so as to automatically learn and integrate to generate an integrated data. And the decision making unit 33 reads the integrated data to adjust the appliances 4 to an operational status which the user is used to.

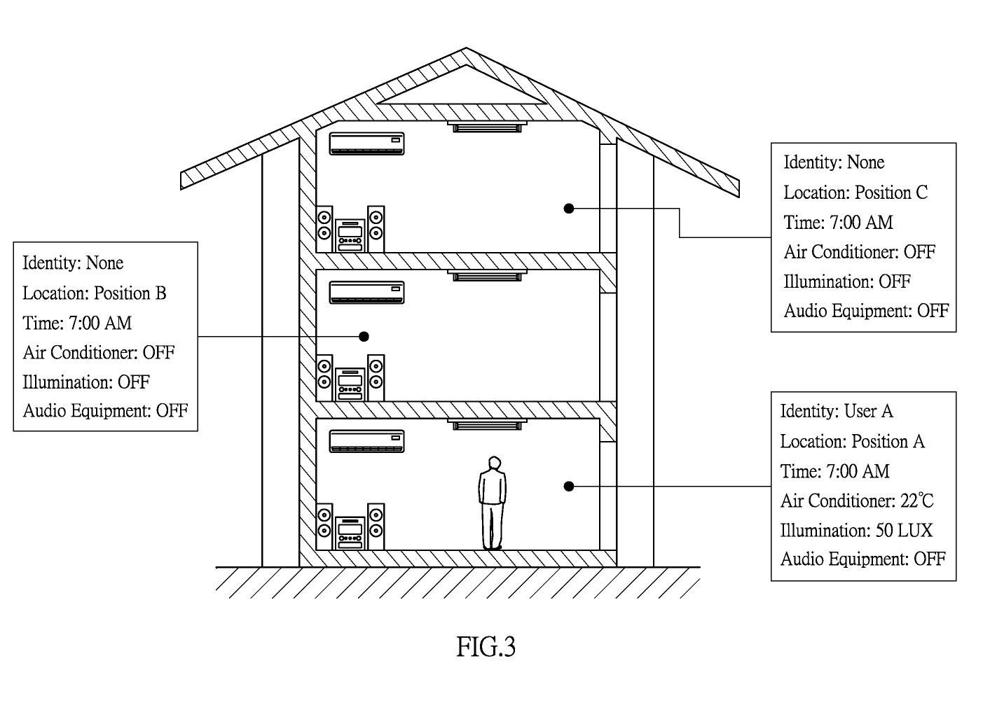

Please refer to FIG. 3, the operation is described as follows. When the user A (FATHER) enters the house and locates at position A (coordinate (1,15)), the identification device 1 may identify the identity of the user A first and then the information of the identity of the user A is transmitted to the artificial neural device 3 and the locating device 2 monitors the position of the user A in the house so as to transmit the information of the position to the recording unit 31 of the artificial neural device 3 to store. Furthermore, the learning unit 32 may learn an environment mode which the user A is used to from the recording unit 31, such that the identity is the user A (FATHER), the information of position is the position A (coordinate (1, 15)), the environment mode is 22° C. (air conditioner's temperature) and 50LUX (illumination), and the audio equipment is turned off. The decision making unit 33 may predict to automatically adjust the temperature of the air conditioner to 22° C., adjust the illumination to 50LUX, and turn of the audio equipment through the learning unit 32 when the user is identified to be the user A and located in the coordinate (1, 15).

Therefore, due to the arrangement of the recording unit 31, the learning unit 32, and the decision making unit 33 of the artificial neural device 3, the appliances 4 may be adjusted to an operational status which the user is used to while the user is located at the specific position with the coordinate so as to achieve the effects of intelligent detection and adjustment.

The advantages of the present invention are to precisely identify the identity and locate corresponding to different users and their customs, to record and predict what the user wants to do through the artificial neural device, and to automatically adjust precisely each appliance 4 in the house to the operational status which the user is used to.

In order to record the time information, the intelligent home system of the present invention further comprises a time tracker 5. The time tracker 5 is electrically connected with the recording unit 31. The time tracker 5 continuously records a staying time of the user who stays in the coordinate and then transmit a time information to the recording unit 31 to store. Accordingly, the learning unit 32 may learn the operational status when the user is located at the specific coordinate, stayed at the specific time, and the operation of the appliances 4 which the user is used to, such that the FATHER is located in coordinate (1,0), stayed at 18:00 pm, and the temperature of the air conditioner is adjusted to 20° C.

In addition, the intelligent home system of the present invention further comprises a plurality of environmental sensors 6. Each environmental sensor 6 is electrically connected with the recording unit 31. Each environmental sensor 6 may detect the inside and outside temperatures and humidity. Therefore, each environmental sensor 6 may be a thermal sensor or humidity sensor so as to monitor an environmental status in the house at any time.

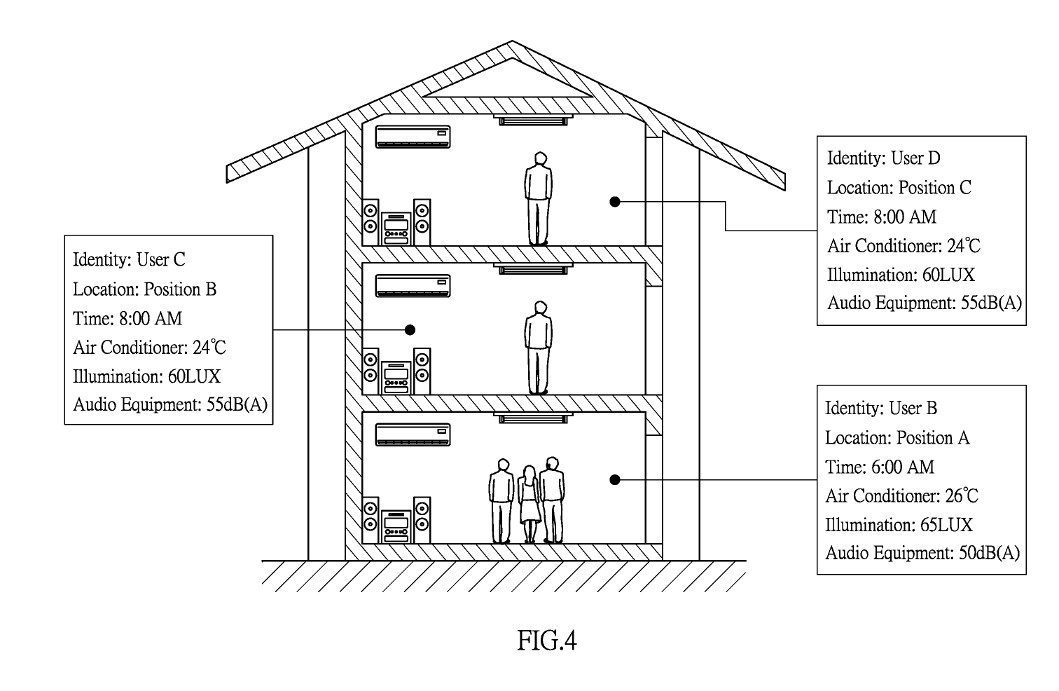

In order to cooperate with multiple users located in the same coordinate, the artificial neural device 3 further comprises a ranking unit 34. The ranking unit 34 is electrically connected with the recording unit 31 and the learning unit 32. The ranking unit 34 stores a plurality of priority information of different users which customizes in the operational status. Please refer to FIG. 4, there are three users located at position A. However, the priority is user 2, user A, and user 3. When they are located at the position A, the artificial neural device 3 may automatically adjust the air conditioner to 26° C., the illumination to 65LUX, and turn the audio equipment to 50 dB(A) according to the operational status which the user 2 is used to.

Additionally, the artificial neural device of the present invention further comprises a judging unit 35. The judging unit 35 is electrically connected with the recording unit 31 and the learning unit 32. A newest control information is read while the judging unit 35 judges that the ID information and the corresponding coordinate information are corresponding to a plurality of control information. For example, the temperature of the air conditioner is 15 while FATHER is located in the coordinate (25,40). But FATHER adjusts the temperature of the air conditioner to 20° C. in the coordinate (25,40) because the temperature is too low. Therefore, the judging unit may automatically judge the new control information to change the predicted operational status.

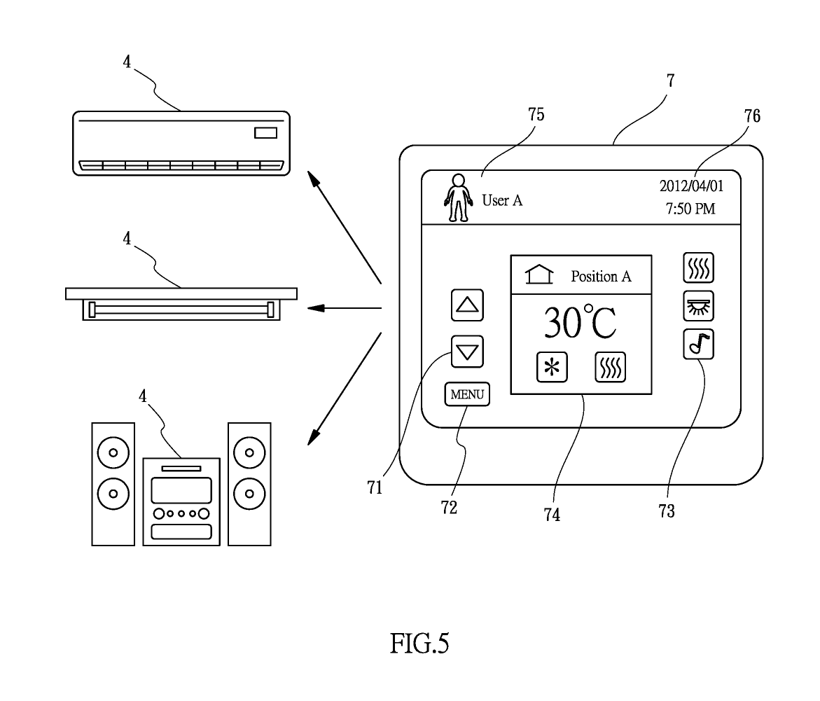

The intelligent home system of the present invention further comprises a controller 7. The controller 7 is electrically connected with the recording unit 31 so as to transmit the control information to the recording unit 31. The controller 7 includes an independent user interface or a corresponding transferring communication apparatus. Please refer to FIG. 5, the controller 7 has the user interface. The user interface may be a touch screen which includes the functions of key-in and display both. In this embodiment, the left side of the user interface is a fine-tune block 71 which has an UP key and a DOWN key so as to fine tune the temperature of the air conditioner. A main menu key 72 is arranged below the fine-tune block 71. The right side of the user interface is an indicating block 73 which may be pressed to control the appliances 4. An environment display block 74 is arranged between the fine-tune block 71 and the indicating block 73. In FIG. 5, the user is located in the position A and the environment temperature is 30° C. The upper-left side of the environment display block 74 is the identity area 75 which shows “user A”. The upper-right side of the environment display block 74 is the date/time area 76 which shows “2012/04/01 7:50 PM”. Therefore, the user may control the appliances 4 with the controller 7 and know the information of the environment status. The controller 7 may be an electronic device, tablet, and so on. The controller 7 may remotely control the artificial neural device 3.

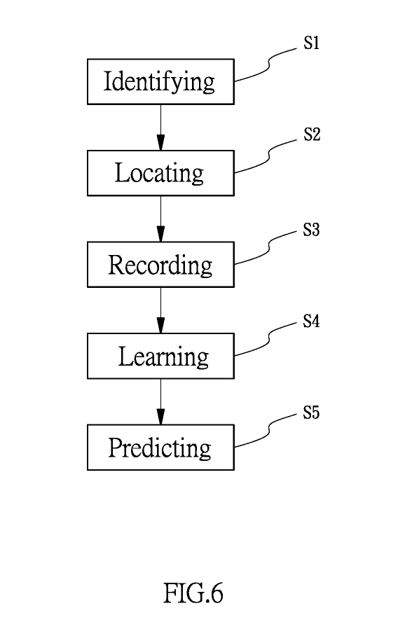

Please refer to FIGS. 1, 5, and 6, an intelligent home method comprises the steps of:
an identifying step S1: identifying the identity of the user with the artificial neural device 3 immediately while the user enters the house;
a locating step S2: detecting the coordinate of the user with the artificial neural device 3 immediately while the user enters the house;
a recording step S3: recording the identity, the coordinate and a control information of each appliance 4 which is adjusted by the user with the artificial neural device 3 at any time;
a learning step S4: automatically learning and integrating an operational status which the user is used to in the coordinate according to the recording step S3; and
a predicting step S5: judging and predicting which appliances 4 the user wants to operate and what kind of the operational status of the appliances 4 is so as to customize for the user by cooperating with the identity and the coordinate after finishing the identifying step S1 and the locating step S2. It may achieve the effects of intelligent detection and prediction.

Accordingly, when the user enters the house, the intelligent home system may automatically adjust the appliances 4 to the operational status which the user is used to through the identifying step S1, the locating step S2, the learning step S4, and the predicting step S5.

The recording step S3 further includes recording a time information recorded by the artificial neural device 3 in a specific coordinate where the user stays and recording the time information, the identity, the coordinate, and the operational status of the appliances in a time interval when the user stays in the specific coordinate with the artificial neural device. In the learning step S4, according to the recording step S3, the artificial neural device 3 automatically learns and integrates the operational status of each appliance 4 which the user is used to corresponding to the time information and the coordinate. In the predicting step S5, according to the learning step S4, which appliances 4 the user wants to operate and what kind of the operational status of the appliances 4 is are judged and predicted so as to customize for the user by cooperating with the identity and the coordinate after finishing the identifying step S1 and the locating step S2.

Besides, the intelligent home method of the present invention further comprises a multiple-user mode step which is performed after the recording step S3 and before the learning step S4. In the identifying step S1 and the locating step S2, when the artificial neural device 3 detects a plurality of identities, a priority is judged in the learning step S4. In the predicting step S5, the artificial neural device 3 judges and predicts which appliances the user wants to operate and what kind of the operational status of the appliances is so as to customize for the user who is the first priority by cooperating with the identity and the coordinate.

The intelligent home method of the present invention further comprises a monitoring environment step. The artificial neural device 3 records a temperature and a humidity inside and outside of the house and monitors the identity of the user in the house, the number of the users in the house, and the operational status of each appliance 4, and then the artificial neural device 3 transmits the information of the identity of the user in the house, the number of the users in the house, and the operational status of each appliance 4 to a display device (not shown) for providing the user to read.

In the learning step S4, the artificial neural device 3 judges whether there is a new control information so as to adjust the appliances 4 to the operational status which the user is used to according to the recording step S3 and cooperating with the identity, the coordinate, and the time information.

Please refer to FIG. 2, the artificial neural device 3 receives the time information, the environment information, and the control information so as to monitor and communicate with the house which the white arrow shows, integrate with the spatial ID information to achieve the effects of identification and location, and output each control information to meet the requirements of the environment, such as temperature control, illumination control, and so on. The information is immediately outputted to various displays, such as tablet, smart phone, or TV to provide the user to understand and the multiple signals (such as audio/video, communication, and security) are outputted to an user control interface.

It is to be understood that the disclosed embodiments are illustrative in nature and the invention is not to be limited to any one or more embodiments except as set forth in the following claims.

What is claimed is:

1. An intelligent home system, installed in a house and interacted with appliances arranged in the house, the system comprising:
an identification device, identified an identity of an user stayed in the house and outputted an ID information of the user;
a locating device, detected a coordinate of the user stayed in the house and outputted a coordinate information; and
an artificial neural device, electrically connected with the identification device and the locating device, the artificial neural device includes a recording unit, a learning unit, and a decision making unit, the recording unit, the learning unit, and the decision making unit are transmitted signals to one another, the recording unit records and stores the ID information, the coordinate information, and a control information of each appliance which is adjusted by the user, the learning unit reads the ID information, the coordinate information, and the control information recorded and stored in the recording unit so as to automatically learn and integrate to generate an integrated data, and the decision making unit reads the integrated data to adjust the appliances to an operational status which the user is used to.

2. The intelligent home system of claim 1, further comprising a time tracker electrically connected with the recording unit, the time tracker continuously records a staying time of the user who stays in the coordinate and then transmit a time information to the recording unit to store.

3. The intelligent home system of claim 2, wherein the artificial neural device further comprises a ranking unit electrically connected with the recording unit and the learning unit, and the ranking unit stores a plurality of priority information of different users which customizes in the operational status.

4. The intelligent home system of claim 3, wherein the artificial neural device further comprises a judging unit electrically connected with the recording unit and the learning unit, and a newest control information is read while the judging unit judges that the ID information and the corresponding coordinate information are corresponding to a plurality of control information.

5. The intelligent home system of claim 4, further comprising a controller, the controller is electrically connected with the recording unit so as to transmit the control information to the recording unit, and the controller includes an independent user interface or a corresponding transferring communication apparatus.

6. An intelligent home method, comprising the steps of:
an identifying step: identifying an identity of an user with an artificial neural device while the user enters a house;
a locating step: detecting a coordinate of the user with the artificial neural device while the user enters the house;
a recording step: recording the identity, the coordinate and a control information of each appliance which is adjusted by the user with the artificial neural device at any time;
a learning step: automatically learning and integrating an operational status which the user is used to in the coordinate according to the recording step; and
a predicting step: judging and predicting which appliances the user wants to operate and what kind of the operational status of the appliances is so as to customize for the user by cooperating with the identity and the coordinate after finishing the identifying step and the locating step.

7. The intelligent home method of claim 6, wherein the recording step further includes recording a time information in a specific coordinate where the user stays and recording the time information, the identity, the coordinate, and the operational status of the appliances in a time interval when the user stays in the specific coordinate with the artificial neural device;
in the learning step, according to the recording step, the artificial neural device automatically learns and integrates the operational status of each appliance which the user is used to corresponding to the time information and the coordinate; and
in the predicting step, according to the learning step, which appliances the user wants to operate and what kind of the operational status of the appliances is are judged and predicted so as to customize for the user by cooperating with the identity and the coordinate after finishing the identifying step and the locating step.

8. The intelligent home method of claim 6, further comprising a multiple-user mode step which is performed after the recording step and before the learning step; in the identifying step and the locating step, when the artificial neural device detects a plurality of identities, a priority is judged in the learning step; in the predicting step, the artificial neural device judges and predicts which appliances the user wants to operate and what kind of the operational status of the appliances is so as to customize for the user who is the first priority by cooperating with the identity and the coordinate.

9. The intelligent home method of claim 6, further comprising a monitoring environment step, the artificial neural device records a temperature and a humidity inside and outside of the house and monitors the identity of the user in the house, the number of the users in the house, and the operational status of each appliance, and then the artificial neural device transmits the information of the identity of the user in the house, the number of the users in the house, and the operational status of each appliance to a display device for providing the user to read.

10. The intelligent home method of claim 6, wherein in the learning step, the artificial neural device judges whether there is a new control information so as to adjust the appliances to the operational status which the user is used to according to the recording step and cooperating with the identity, the coordinate, and the time information.
